(19) United States
(12) Patent Application Publication
(10) Pub. No.: US 2006/0236156 A1
(43) Pub. Date: Oct. 19, 2006

(54) Methods and apparatus for handling code coverage data

(75) Inventors: John Anderson Cunningham, Kirkland, WA (US); Steven M. Carroll, Sammamish, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/106,869

(22) Filed: Apr. 15, 2005

(51) Int. Cl. G06F 11/00

(52) U.S. Cl. 714/38

(57) ABSTRACT

In one aspect, a method and apparatus for formatting code coverage data generated by performing one or more code coverage tests on a program module derived from computer code is provided, including organizing the code coverage data in a hierarchy having a plurality of tables, each of the plurality of tables configured to store information at one of successive levels of refinement, and storing, in each of the plurality of tables, code coverage information indicative of code coverage at a respective one of the successive levels of refinement. In another aspect, a data structure for storing code coverage data is provided, the data structure comprising a plurality of tables organized in a hierarchy having a plurality of levels, each of the plurality of levels corresponding to a respective construct in the programming paradigm used to structure the code, wherein each of the plurality of tables comprises a first location configured to store code coverage information at the level in the hierarchy at which the table is located.

### FIELD OF THE INVENTION

The present invention relates to code coverage tests and more particularly to organizing and analyzing code coverage data obtained from one or more code coverage tests.

### BACKGROUND OF THE INVENTION

During the development and testing of computer code, it may be desirable to understand which code gets executed in response to a given a set of inputs designed to interrogate the code (often referred to as test vectors). For example, a module such as a dynamic link library (DLL) may undergo one or more code coverage tests using a battery of test input vectors to see which portions of the code are being executed and which are not. Code coverage data resulting from the code coverage tests may be used as a metric to determine the effectiveness of test inputs, to identify high risk portions of the code, to locate so-called dead code that is not being executed, expose various faults in the code, etc.

The term “code” refers to herein to any manifestation of a program to be executed on a processor. For example, code generically describes both source code in one or more higher level languages and object or assembly code, for example, produced by a compiler. In addition, code may refer to any intermediate translations such as byte codes, etc. In general, a specific manifestation will be indicated by an additional modifier such as “source code” or “assembly code,” when a particular distinction may be required for clarity.

Code coverage analysis is often used to measure the effectiveness of a set of tests that, for example, a quality assurance (QA) team performs on a test build of a program or application to determine the robustness of the code. By examining what code is being exercised in response to the set of tests, it can be determined whether the tests should be modified or new tests implemented to exercise more of the code. That is, code coverage analysis may be used to determine the exhaustiveness of a test plan designed for a particular application or product under development. In response, the test plan may be modified and/or supplanted to improve the general thoroughness of the testing.

Code coverage data obtained from a code coverage test typically reports on line coverage and block coverage of a particular test build. Line coverage (also referred to as statement coverage) refers to whether a single line or statement of code is exercised and typically refers to the highest level manifestation of the code (e.g., the source code). Block coverage refers to whether a block of code characterized by a single entry and exit point (e.g., a non-branching statement or series of non-branching statements) has been exercised and is typically analyzed at the assembly code level.

Conventional code coverage analysis provides data on a line by line and/or block by block basis with an indication as to whether the respective line or block was covered. In many conventional implementations, code coverage analysis is handled by a relatively complex and expensive infrastructure. For example, a database server machine may be dedicated to storing and handling code coverage data obtained from daily, weekly or other periodic test builds and providing code coverage analysis for the builds. After the test build has been processed and analyzed by the server, the results may be distributed to the developers involved in developing the code, implementing bug fixes, etc.

### SUMMARY OF THE INVENTION

To facilitate simpler analysis and interpretation of results generated from code coverage tests, code coverage data may be organized in a hierarchy that allows the code coverage data to be viewed at a number of different levels of detail. For example, code coverage data may be organized hierarchically in tables that store coverage information at successive levels of refinement. In one embodiment, a hierarchy may be organized to reflect the structure of constructs in the programming paradigm used to develop the code, so that results may be viewed in the same context as the code from which the results were generated. In other aspects of the invention, code coverage analysis is facilitated by leveraging technologies such as the .NET Framework and ADO.NET, to provide a light-weight and relatively inexpensive infrastructure for database manipulation and code coverage analysis at the desktop.

One aspect of the invention includes a method of formatting code coverage data generated by performing one or more code coverage tests on a program module derived from computer code, the method comprising acts of organizing the code coverage data in a hierarchy having a plurality of tables, each of the plurality of tables configured to store information at one of successive levels of refinement, and storing, in each of the plurality of tables, code coverage information indicative of code coverage at a respective one of the successive levels of refinement.

Another aspect of the invention includes a data structure for storing code coverage data generated by performing one or more code coverage tests on a program module derived from computer code, the data structure comprising a plurality of tables organized in a hierarchy having a plurality of levels, each of the plurality of levels corresponding to a respective construct in the programming paradigm used to structure the code, wherein each of the plurality of tables comprises a first location configured to store code coverage information at the level in the hierarchy at which the table is located.

Another aspect of the invention includes a method of formatting code coverage data generated from performing one or more code coverage tests on a program module derived from computer code, the method comprising acts of organizing the code coverage data in a plurality of tables arranged in a hierarchy having a plurality of levels, each of the plurality of levels corresponding to a respective construct in the programming paradigm used to structure the code, and storing, in each of the plurality of tables, code coverage information at the level in the hierarchy at which the table is located.

### BRIEF DESCRIPTION OF THE DRAWINGS

FIG. 1 illustrates a hierarchy having multiple levels of refinement to store code coverage data arranged to reflect the structure of the code, in accordance with one embodiment of the present invention;

FIG. 2 illustrates a hierarchy having multiple levels of refinement that may be implemented as an ADO.NET DataSet object, in accordance with one embodiment of the present invention;

FIG. 3 illustrates a method for populating the hierarchy illustrated in FIG. 2, in accordance with one embodiment of the present invention;

FIG. 4 illustrates the hierarchy of FIG. 2 with additional line and source file tables, in accordance with another embodiment of the present invention;

FIG. 5 illustrates a ConstructTables( ) function which may operate as the main algorithm for populating a hierarchy with code coverage data, in accordance with one embodiment of the present invention;

FIG. 6 illustrates a function GetBlocksForMethod( ) that, given a list of blocks sorted in RVA order, a method RVA and the size of the method, returns a list of blocks contained within the method, in accordance with one embodiment of the present invention; and

FIG. 7 illustrates a ProcessLine( ) function that determines whether a line is fully or partially covered, in accordance with one embodiment of the present invention.

### DETAILED DESCRIPTION

Conventional code coverage analysis may provide a database of information related to line and/or block coverage. For example, the database may include a series of entries specifying an index to the start of a line of source code (line start), an index to the end of the line of source code (line end) and an indication as to whether the corresponding line of code was covered during the code coverage test. Similarly, the database may include a list of entries specifying the start and end of a block of assembly code and an indication of whether the block was covered. However, this information may be relatively hard to analyze and/or interpret. For example, this data doesn't immediately convey information about which portions of the code are being exercised, how and where the exercised code is distributed, and where missed code is located, etc., without performing additional manipulations on the coverage data.

In circumstances where code coverage analysis is performed to plan test suites that exercise a substantial amount, if not all, of the code, the data provides little guidance as to how the test suite should be modified and/or what new tests should be designed to cover more of the code during testing. Moreover, in situations where code coverage analysis is being performed to locate dead code, or to identify vulnerable portions of the code (e.g., high traffic areas), the conventional coverage data may not be particularly informative. Furthermore, code developers may be interested in code coverage data at a different level of detail than, for example, test engineers, project managers, etc. Conventional code coverage data makes it difficult for the data to be interpreted at a desired scale or level of detail.

Applicant has identified and appreciated that by structuring code coverage data, richer information may be provided for analysis and interpretation of the results. In one embodiment, code coverage results are organized hierarchically in tables that store coverage information at successive levels of refinement. For example, a hierarchy may be organized to reflect the structure of constructs in the programming paradigm used to develop the code. In one embodiment, the code is structured according to an object oriented programming paradigm. For example, a module table may include coverage information for an entire module of code. Underneath the module table in the hierarchy, one or more class tables may be provided to store coverage information about respective classes defined in the module of code. At a further level of refinement, one or more method tables may store coverage information about any methods defined in the class definitions. By organizing the hierarchy to reflect the structure of the code being tested, simpler and more effective analysis of code coverage results may be facilitated.

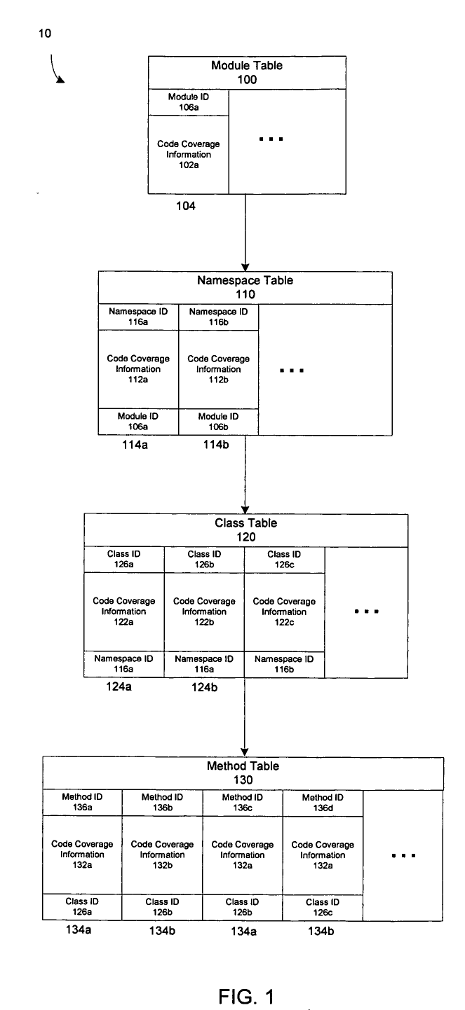

FIG. 1 illustrates a data structure for organizing code coverage results in a hierarchy, in accordance with one embodiment of the present invention. One or more code coverage tests may be performed on a module to determine, for example, which code is being executed in response to a predetermined set of inputs and which code is not. The term “module” refers herein to any discrete program compiled from or comprising a collection of code. For example, a module may be a standalone application or other program, a static library, a dynamic linked library (DLL), a plug-in, a component object model (COM) object, one or more COM interfaces or any other program containing instructions capable of being executed by one or more processors.

The results from the one or more code coverage tests may be parsed and formatted in hierarchy 10 to, in part, facilitate data analysis. In the embodiment in FIG. 1, the module on which the code coverage test was performed may have been compiled from source code written in an object oriented language. Accordingly, hierarchy 10 may be organized to reflect the structure of the programming paradigm used in developing the module, thus providing an understandable context for the code coverage data. In particular, hierarchy 10 may be comprised of a plurality of levels providing successively refined detail with respect to code coverage information. The term “code coverage information” refers herein to any data indicative of code execution during one or more code coverage tests. For example, code coverage information may include, but is not limited to, any one or combination of block coverage data, line coverage data, whether a method or function has been called, the number of times a portion of code is executed, etc.

Hierarchy 10 includes four levels corresponding to module, namespace, class and method levels of refinement. The module level includes a module table 100 having an entry 104 for storing, amongst other data, code coverage information 102 about the module as a whole. Entry 104 may include a module ID 106a that identifies the module and the module entry. The module table includes as a child a namespace table 110 for storing code coverage information 112 at the namespace level. As is understood in the art, namespaces are constructs used, at least in part, to avoid naming conflicts. For example, one or more classes may be defined in a namespace such that names in classes declared within different namespaces may be identical without causing naming conflicts during compiling, linking, etc. The namespace table may include one or more entries corresponding to respective namespaces defined in the module. For example, namespace table 110 may include an entry 114a storing various data related to a first namespace. For example, namespace entry 114a may include namespace ID 116a to identify the namespace, code coverage information 112a to store data indicating code coverage in the namespace, and module ID 106a to identify the module to which the namespace belongs. In FIG. 1, namespace table 110 also includes an entry 114b to store code coverage information 112b. The namespace level provides a level of detail more refined than the module level. For example, block and/or line coverage statistics may be viewed for each namespace, rather than for the module as a whole.

The class level includes class table 120 having one or more entries 124 to store code coverage information 122 about one or more classes defined in respective namespaces of the module. As discussed above, one or more classes may be defined in each of the namespaces indicated by IDs 116. A class entry 124 may be allocated for each class in the namespace in which it is declared and/or defined. For example, class entry 124a and class entry 124b store code coverage information corresponding to two classes defined in a namespace associated with namespace ID 116a. Similarly, class entry 124c may be allocated to store code coverage information corresponding to a class defined in a namespace identified by namespace ID 116b. Each class entry may include the namespace ID of the namespace that it belongs to. Including a reference to the parent table entry simplifies the process of providing to and updating coverage information in the hierarchy, as discussed in further detail below. Class tables may be allocated for any number of classes for which code coverage information is desired. The code coverage information may include any measure of code coverage within the respective class, thus adding a further level of refinement and detail to the code coverage data.

The method level includes method table 130 having entries to store code coverage information 132 corresponding to methods declared and/or defined in respective classes in class table 120. For example, method entries 134a may be a method defined within the class identified by class ID 126a, method entries 134b and 134c may be methods defined within the class identified by class ID 126b, method entry 134d may be a method defined within the class identified by class ID 126c, etc. Similarly, one or more method entries may be allocated to store code coverage information corresponding to methods defined in any of the other classes. It should be appreciated that any number of method tables may be allocated, as the aspects of the invention are not limited in this respect. The method level further refines the detail by which code coverage results may be viewed, interpreted and/or analyzed.

By organizing the code coverage data in a hierarchy, the information may be more easily understood. For example, a software developer may query information about code coverage in a particular method, in a desired class, in the entire namespace, or in the module as a whole. In addition, having the ability to view and understand the distribution of code coverage results may make it easier for test engineers to develop tests that exercise more of the code in a module. For example, by being able to determine the code coverage in a particular class (and the methods in the class) a test engineer may be better able to determine the character and nature of test inputs that will exercise methods that were not covered during the test or increase coverage in identified methods. In addition, a software developer may be able to quickly identify missed code expected to be exercised, and due to the organization of the coverage data, determine problems in the functioning or flow of the code that results in the code not being executed. The software developer may then be able to implement a fix for the problem. Because code coverage results are available at a variety of levels of refinement, a user may analyze the results at a detail most relevant to the user, whether the user is a software developer, a test engineer or a program manager.

It should be appreciated that other hierarchies may be used, as the aspects of the invention are not limited in this respect. For example, a hierarchy having any desired levels of refinement may be provided. Moreover, any number of tables and entries in the tables may be allocated in each of the levels of the hierarchy and may store any type of code coverage information (e.g., block coverage statistics, line coverage statistics, etc.) In addition, it should be appreciated that a hierarchy providing multiple levels of refinements may be designed to reflect any structure, and particularly, the structure of code written in any of various programming paradigms. For instance, the class level may be replaced by a struct level in structured programming languages such as C. Similarly, the method level may be replaced by a function level to provide a view of code coverage at the function level of the code. It should be appreciated that the levels may be chosen to associate coverage data with any sort of structure, and any hierarchy that organizes code coverage information at successive levels of refinement may be suitable for use with the various aspects the invention.

In conventional software development environments, a periodic (e.g., daily or weekly) test build of an application or some particular module is released to a QA team having one or more test engineers for testing. During testing, the QA team may perform one or more code coverage tests on the test build. The code coverage data may be stored in a relatively large database, or database server operated by the QA team. The code coverage results may then be distributed to software developers who may be interested in the results or who may need to perform further analysis on the data. As discussed above, conventional code coverage data is often presented such that only rudimentary analysis is possible without performing further manipulations on the data.

Moreover, because the databases used to store test results, and more particularly, code coverage results are often expensive and non-trivial to set-up and maintain, a software company may incur the overhead of setting up one or a small number of such databases to be operated and maintained by the QA team. In general, the overhead involved in obtaining a database license and the expense of setting up and maintaining such a database infrastructure for each software developer is too prohibitive. As a result, a software developer must wait for a build to be released, tested and the results distributed before any action can be taken, precluding the software developer from running his own unit tests before checking in modified code, bug fixes, and/or new test input vectors, etc. Accordingly, issues that may have been more efficiently identified and fixed by a software developer during a unit test will be released into the periodic build and must wait the relatively long period for release and distribution before being remedied. This inability to quickly and easily perform code coverage tests at the desktop may create bottlenecks and inefficiencies in the software development process.

Applicant has appreciated that a light weight, relatively inexpensive desktop solution to code coverage testing may facilitate more efficient software development and a quicker software release cycle. In one embodiment, the .NET framework operates as the database framework and code coverage results are organized as ActiveX Database Objects (ADO) in the .NET framework (i.e., ADO.NET). The ADO.NET solution provides an inexpensive, lightweight database solution that allows a software developer to analyze code coverage results (e.g., by making any desired database query) at the desktop.

The .NET framework is a development and execution environment that allows different programming languages and libraries to work together to, amongst other things, create Microsoft® Windows-based applications. The NET framework facilitates building, managing, deploying, and integrating applications with other networked systems. In the context of database integration, the .NET Framework includes a collection of classes designed to communicate with a specific type of data source. The .NET Framework comes pre-built with data providers for SQL Server, OLE-DB sources, Oracle, and ODBC as well as additional data providers that have been made available. Accordingly, relatively expensive database infrastructure may be replaced with the NET framework. Those skilled in the art will be familiar with the NET Framework and will not be discussed in detail herein. Resources are publicly available online, for example, at http://msdn.microsoft.com/netframework/default.aspx, which is herein incorporated by reference in its entirety.

ADO.NET includes, in part, a set of libraries that are designed to communicate with a variety of back-end data stores, databases, etc. In particular, ADO.NET includes libraries that enable data source connection, query submission, and processing results. ADO.NET provides a hierarchical, disconnected data cache that works offline and online via a DataSet object that facilitates searching, filtering, navigation and storage. An advantage of the DataSet object is that it can be used independently within the .NET Framework to manage locally stored data or XML files. Moreover, ADO.NET can be used within the .NET Framework to communicate with and interact with databases over a network. The DataSet object also provides the ability to read and write data to and from a file or an area of memory, allowing for the contents of a DataSet object to be saved as, for example, an XML document.

The NET Framework and ADO.NET may come bundled with various development software, for example, Visual Studio® from Microsoft Corporation®. As a result, software developers may already have everything they need in their development environment to organize, search, query and navigate a database storing code coverage results. In addition, the DataSet object allow coverage data to be organized and stored in a hierarchy in a manner complimentary for use with the various aspects of the present invention. Since ADO.NET is based on and tightly integrated with XML, XML schema may be easily published and distributed as, for example, a web page displaying results of one or more code coverage tests. ADO.NET will be familiar to those skilled in the art and will not be discussed in detail herein. Resources detailing ADO.NET are publicly available, for example, at http://msdn.microsoft.com/netframework/default.aspx, which is herein incorporated by reference in its entirety.

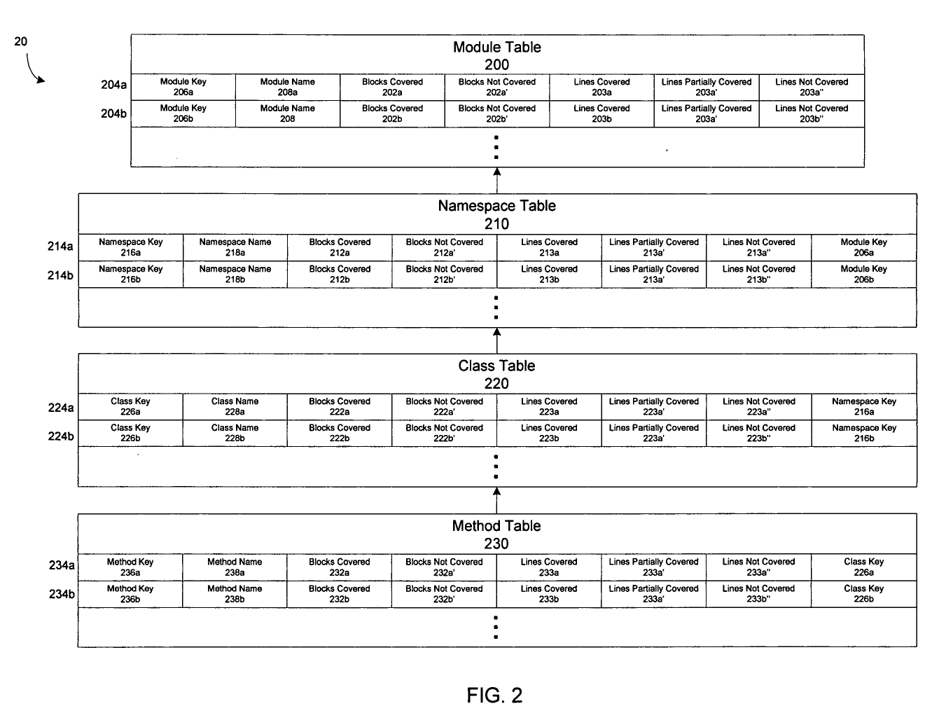

FIG. 2 illustrates an example of a hierarchy for storing code coverage results, in accordance with one embodiment of the present invention. Hierarchy 20 may represent an ADO.NET DataSet object to be populated with code coverage data generated from one or more code coverage tests performed on a module of code. The structure of hierarchy 20 may be similar to hierarchy 10 illustrated in FIG. 1. However, the structure in hierarchy 20 may be instantiated and maintained as a DataSet object. For example, a new DataSet object may be instantiated with a module table, a namespace table, a class table and a method table to form a hierarchy that reflects the structure of the programming paradigm used to design and implement the module. It should be appreciated that the DataSet object may be instantiated with any number of tables reflecting any desired levels of refinement indicative of any type of structure, as the aspects of the invention are not limited in this respect.

The DataSet class includes methods to allocate and add tables to a DataSet object. In FIG. 2, a DataSet object may be instantiated with multiple tables allocated and added to the object. For example, the DataSet object to store hierarchy 20 may include a module table 200, a namespace table 210, a class table 220 and a method table 230, to store coverage data at respective levels of refinement. The DataSet class also includes methods for allocating and adding rows to the tables. Each row may include one or more row elements. A row may be added for each instance of structure in the hierarchy (e.g., for each method, class, namespace and/or module) for which coverage data may be available. For example, a row may be allocated and added to module table 200 for each module on which a code coverage test was performed. FIG. 2 illustrates exemplary rows 204a and 204b to store code coverage data for modules identified by module ID 206a and 206b, respectively. Each row includes row elements to store an identification of the module, block coverage statistics and line coverage statistics.

Similarly, a row may be allocated and added for each namespace defined in the one or more modules. For each namespace row, row elements may be allocated to store a namespace ID, block coverage statistics and line coverage statistics. In addition, a namespace row may include a row element to store the module ID of the module in which the namespace is defined. Likewise, rows may be allocated and added to the class and method tables for each respective class and method defined to respective modules to store block and line statistics and an identification of the parent row in the preceding level of refinement to which it belongs. Once the DataSet object has been instantiated, it may be populated with information stored in the code coverage data. For example, the coverage data may be stored as a list of blocks of code belonging to each module on which coverage tests were performed. Each block may be represented by a block index, the relative virtual address (RVA) of the block in the assembly code, the size of the block in bytes and a bit indicating whether the block was covered during the corresponding code coverage test. It should be appreciated that coverage data may come in a variety of formats and the aspects of the invention are not limited in this respect, as a structured hierarchy may be populated with coverage data of any format, type and/or character.

In addition to coverage data, debug information may be used to facilitate populating the hierarchy. In particular, debug information (e.g., debug information generated when the module(s) was compiled) such as Common Language Runtime (CLR) metadata or Program Database (PDB) debug information, may be used to map the blocks indicated in the coverage data to respective locations in the source code to facilitate determination of line coverage information that may be used to populate the hierarchy (e.g., to populate a DataSet object).

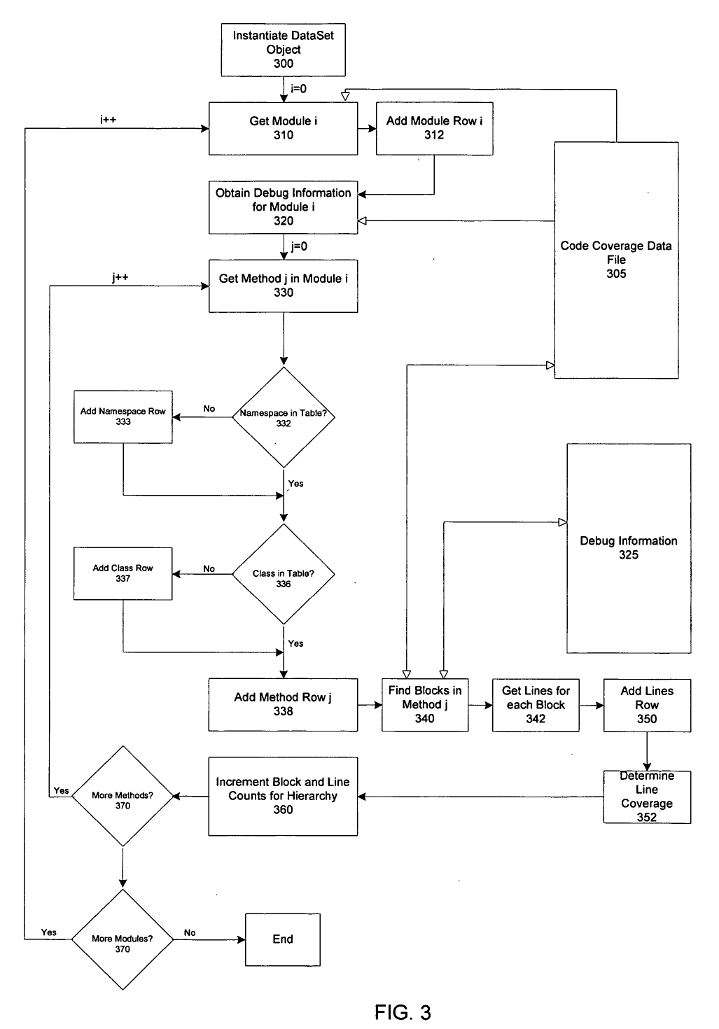

FIG. 3 is a flow-chart illustrating a method for populating a structured hierarchy with code coverage data, in accordance with one embodiment of the present invention. For example, the method illustrated in FIG. 3 may be used to populate hierarchy 20 in FIG. 2. In step 300, the DataSet object may be instantiated with a plurality of tables, including: 1) a module table 200; 2) a namespace table 210; 3) a class table 220; and 4) a method table 230. The code coverage data may then be obtained to populate the instantiated DataSet object. The code coverage data may be obtained from a network database, or may be generated at a desktop location and stored locally.

The code coverage data may be of any type and nature that indicates code exercised during one or more code coverage tests. As discussed above, code coverage data may be a list of blocks that exist in each module, wherein each block is represented by a block item including a block index, the RVA of the block in the assembly code, the size of the block, and a bit indicating whether the block is covered. The coverage data may be stored in code coverage data file 305, which may be accessible locally or over a network.

In step 310, a module i having coverage data in code coverage data file 305 is selected for processing. A new row corresponding to the module i may be allocated and added to module table 200 (step 312). The new module row may be instantiated with enough row elements to store desired information about module i. For example, the new module row may be instantiated with a row element to store the name of the module (and/or any other identification mechanism to uniquely identify the module such as link time, module size, etc.), row elements to store one or more block coverage statistics, one or more line coverage statistics, and/or any other code coverage information, debug information, etc., that may be desirable.

In step 320, debug information 325 for module i is obtained. As discussed above, the debug information may include information generated at compile time that maps blocks of assembly code to corresponding locations in the source code. The debug information may be used to determine which lines of code are associated with which blocks, and to determine which construct in the source code a block belongs. For example, debug information 325 may be used to map a block of code to the method, class, namespace, etc. to which the block of code belongs.

In step 330, a method j located in module i is selected for processing so that code coverage information about the method may be provided to appropriate locations in the DataSet object. It may be determined that method j is defined in module i by interrogating debug information 325. Also from the debug information, the namespace to which method j belongs is identified and a check is made as to whether the namespace has a row allocated to it in the namespace table 210 (step 332). If the namespace does not exist, a new namespace row is allocated and added to the namespace table 210 to store coverage information about the namespace (step 333). The class to which method j belongs is also identified and a check is made as to whether the class has a row allocated to it in the class table 220 (step 336), and a new class row is added if the class is not found (step 337). A new method row may then be added to method table 230 to store code coverage information about method j (step 338).

In step 340, the coverage data file 305 and debug information 325 are utilized to associate methods with the code blocks that were compiled from the methods. For example, each block of code belonging to the method is obtained from coverage data file 305 by examining the mapping between blocks and lines of code that form the method. Using debug information 325, the line in the source code for each block is identified (step 342). It may be desirable to store line information determined from the debug information so that it can be accessed at a later time, for example, when analyzing or publishing code coverage results.

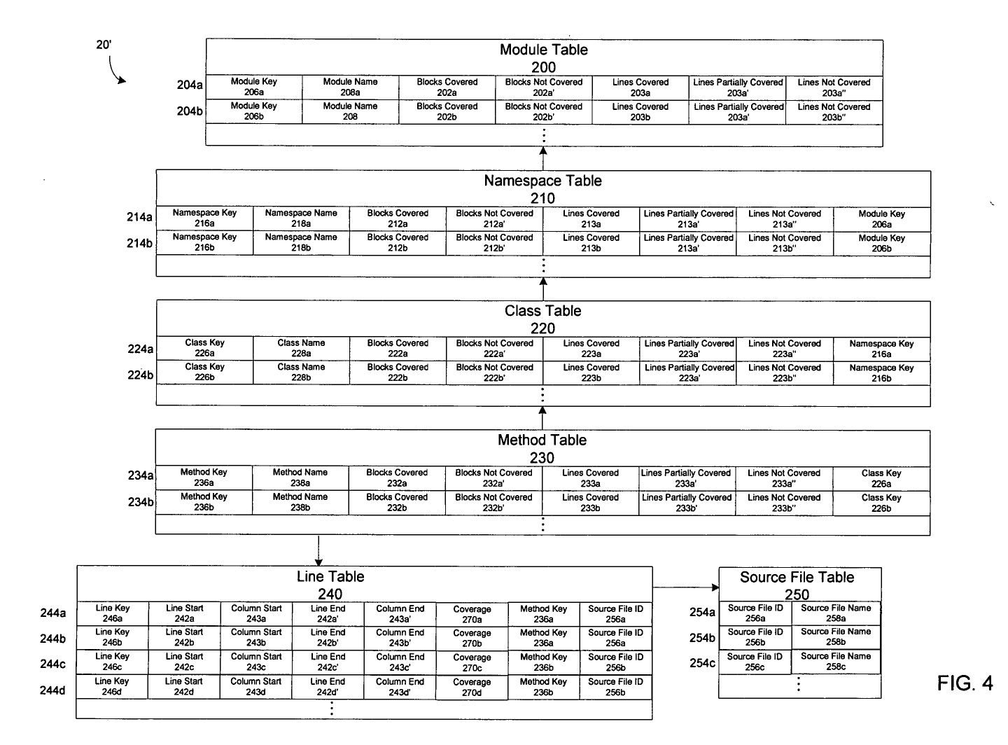

FIG. 4 illustrates a line table 240 organized as a further level of refinement (or child) of method table 230. Line table 240 may be allocated and added to the DataSet object to store line coverage information. For example, the line table may include a row for each line in a method and row elements that identify the start and end of the line, an indication of whether the line is covered, and an identifier indicating to which method the line belongs. Line table 240 includes exemplary line entries 244a-244d. Each line entry includes a line key 246 (e.g., line keys 246a-246d) to store identification information about the line. In addition, each line entry further includes a line start 242, column start 243, line end 242′ and column end 243′ to specify the location of the line in the source file and coverage 270 to indicated whether the line is covered. Line entries in line table 240 also include a method key 236 to identify the method that the line belongs to and a source file ID 256 to indicate the source file in which the line appears.

Hierarchy 20′ in FIG. 4 also includes a source file table 250 that maps lines of code to the corresponding source file. Source file table 250 illustrates exemplary source file entries 254 (e.g., 254a-254c). Each source file entry includes a source file ID 256 which identifies the source file (e.g., to provide a reference for corresponding line entries in line table 240) and source file name 258 to store the name of the source file. Source file table 250 may be allocated and added to the DataSet object storing the code coverage hierarchy.

In step 350, a new line row is added to the line table for each line identified in step 342, allocating row elements to store corresponding line information. For example, each line row may include a row element to store any one of or combination of line start and line end, column start and column end to locate the line in the source file, and a value to indicate whether the line is covered, partially covered, or not covered. In step 352, whether each line is covered, partially covered, or not covered is determined based on the block coverage data. The line statistics are then provided to the appropriate row element of the corresponding line row.

In step 360, block and line statistics are propagated up through the hierarchy. For example, the block and line coverage information stored in tables 200-230 may represent counts for the corresponding statistic. The line coverage determination in step 352 may be used to increment the appropriate count in the corresponding row of the method, class, namespace and module tables. Likewise, the block coverage information may be used to increment the appropriate counts in each of the tables in the hierarchy. In step 370, after each block in method 335i has been processed, a check is made to determine whether more methods exist in the current module. If so, steps 330-360 are repeated with the next method. If not, a check is made as to whether more modules exist (step 372) and if so, steps 310-370 are repeated. If not, the hierarchy may be deemed fully populated. The populated hierarchy may then be queried, analyzed, visualized, published or otherwise manipulated to gain an understanding of the code coverage results.

A DataSet object is tightly linked with XML. Accordingly, once the DataSet object is populated it may be saved as an XML document, published as a webpage, and/or distributed over a network. The DataSet object may be queried to obtain any information at the various levels of detail as desired. Accordingly, the DataSet object may provide a richer data experience at levels of refinement that are meaningful to the various people involved in the software development process (e.g., software developers, test engineers, managers, etc. may view the coverage data at a level of detail most useful for them to understand the results). In addition, it should be appreciated that utilization of ADO.NET enables a lightweight, on the fly database infrastructure that allows a software developer to perform code coverage analysis at the desktop without having to license, install and maintain relatively expensive conventional database infrastructures, both from the cost and space perspective.

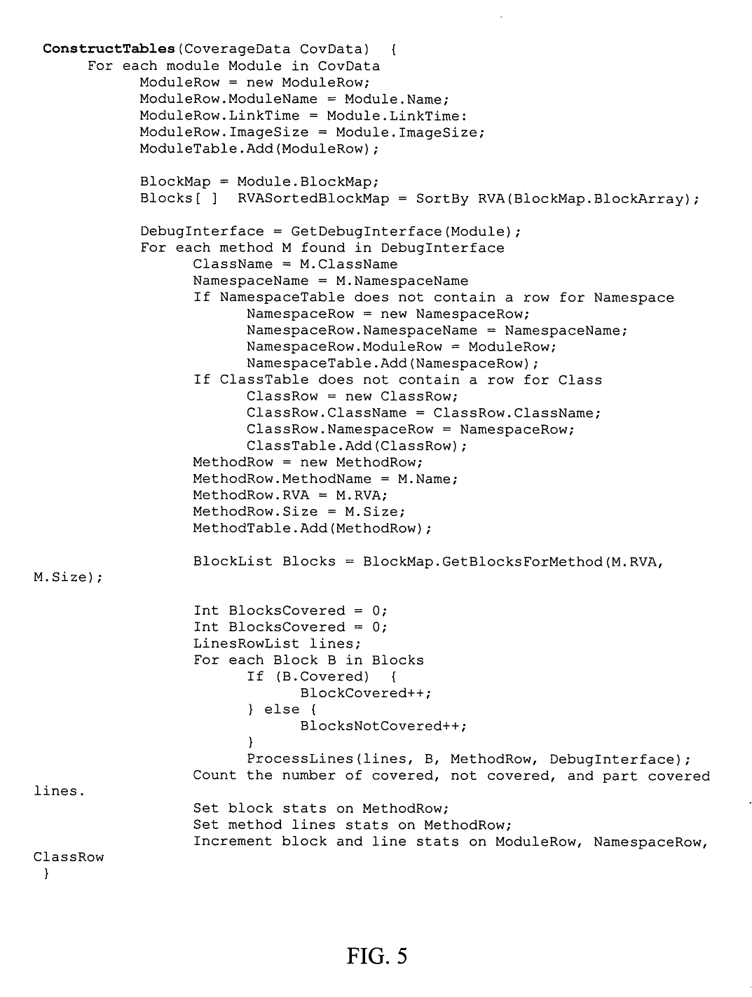

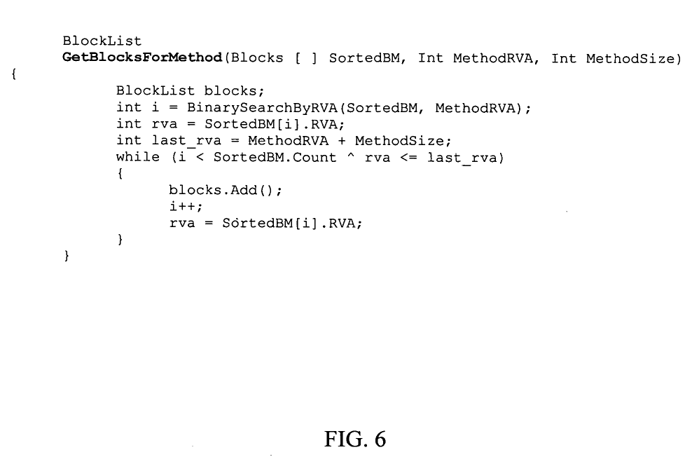

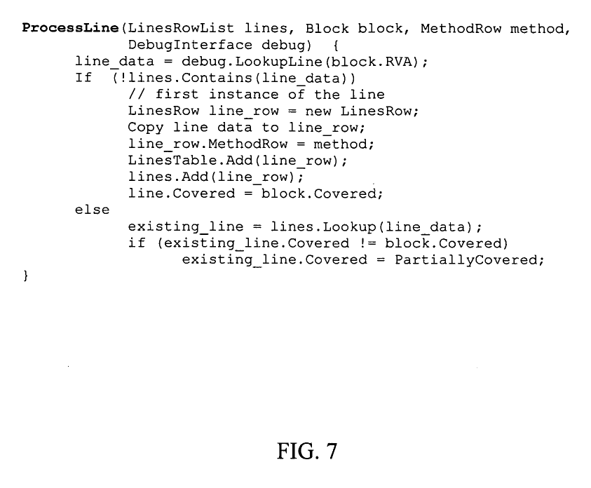

It should be appreciated that the method in FIG. 3 may be implemented in numerous ways. In one embodiment, the method is implemented as a computer program, some exemplary code of which is shown in FIGS. 5-7. FIG. 5 illustrates a ConstructTables( ) function which may operate as the main algorithm for populating a hierarchy with code coverage data. FIG. 6 illustrates a function GetBlocksForMethod( ) that, given a list of blocks sorted in RVA order, a method RVA and the size of the method, returns a list of blocks contained within the method. FIG. 7 illustrates a ProcessLine( ) function that determines whether a line is fully or partially covered.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. The invention is capable of other embodiments and of being practiced or of being carried out in various ways. In particular, various aspects of the invention may be used with hierarchies having any of numerous levels defining successive refinement and may be organized to reflect structure of any type, nature or character. In addition, any of various data structures may be used to implement a hierarchy, as the aspects of the invention are not limited in this respect.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method of formatting code coverage data generated by performing one or more code coverage tests on a program module derived from computer code, the method comprising acts of:
organizing the code coverage data in a hierarchy having a plurality of tables, each of the plurality of tables configured to store information at one of successive levels of refinement; and
storing, in each of the plurality of tables, code coverage information indicative of code coverage at a respective one of the successive levels of refinement.

2. The method claim 1, wherein the successive levels of refinement reflect constructs in a programming paradigm used to structure the code, and wherein the act of organizing the code coverage data includes an act of organizing the code coverage data in a hierarchy having a class table to store code coverage information corresponding to at least one class defined in the code, and a method table to store code coverage information corresponding to at least one method defined in the at least one class.

3. The method of claim 2, wherein the act of storing includes acts of:
storing, in the class table, at least one block coverage value indicating a number of blocks covered and a number of blocks not covered in the at least one class, and at least one line coverage value indicating a number of lines covered and a number of lines not covered in the at least one class; and
storing, in the method table, at least one block coverage value indicating a number of blocks covered and a number of blocks not covered in the at least one method, and at least one line coverage value indicating a number of lines covered and a number of lines not covered in the at least one method.

4. The method of claim 2, wherein the act of organizing the results includes an act of organizing the results in a hierarchy having a module table to store code coverage information corresponding to the program module and a namespace table to store code coverage information corresponding to at least one namespace defined in the code.

5. The method of claim 4, wherein the namespace table includes a namespace entry for each namespace in the module, the class table includes a class entry for each class in each namespace, and the method table includes a method entry for each method in each class, and wherein the act of storing code coverage information includes an act of storing, in each namespace entry, class entry, and method entry, at least block coverage information and line coverage information for the respective entry.

6. The method of claim 4, wherein the act of organizing the results includes an act of organizing the results in a hierarchy including a line table having a line entry for each line in the code from which the module is derived, each line entry including information indicating a start and an end of a line and an indication whether the line is covered, not covered, or partially covered.

7. The method of claim 5, wherein the successive levels of refinement are organized from coarse to fine code coverage information, proceeding in a hierarchical order from the module table, to the namespace table, to the class table and to the method table.

8. The method of claim 7, further comprising an act of storing, in each entry of the plurality of tables, an identification of the entry and an identification of the entry in the previous level of refinement from which it depends in the hierarchical order.

9. The method of claim 5, wherein the hierarchy is stored as at least one ADO.NET DataSet object, and wherein the act of storing includes an act of populating the at least one DataSet object with the code coverage information.

10. A data structure for storing code coverage data generated by performing one or more code coverage tests on a program module derived from computer code structured according to a programming paradigm, the data structure comprising:
a plurality of tables organized in a hierarchy having a plurality of levels, each of the plurality of levels corresponding to a respective construct in the programming paradigm used to structure the code, wherein each of the plurality of tables comprises a first location configured to store code coverage information at the level in the hierarchy at which the table is located.

11. The data structure of claim 10, wherein the programming paradigm is object oriented programming, and wherein the plurality of tables include a class table configured to store coverage information about at least one class defined in the code and a method table configured to store coverage information about at least one method defined in the at least one class.

12. The data structure of claim 11, wherein the class table includes an entry for a plurality of classes defined in the code, each entry comprising:
at least one block storage location to store at least one value indicating a number of blocks covered and a number of blocks not covered in the respective class; and
at least one line storage location to store at least one value indicating a number of lines covered and a number of lines not covered in the respective class.

13. The data structure of claim 12, wherein the method table includes an entry for a plurality of methods defined in the code, each entry comprising:
at least one block storage location to store at least one value indicating a number of blocks covered and a number of blocks not covered in the respective method; and
at least one line storage location to store at least one value indicating a number of lines covered and a number of lines not covered in the respective method.

14. The data structure of claim 2, wherein the plurality of tables includes at least one module table configured to store coverage information about the module and a namespace table to store coverage information about at least one namespace defined in the code.

15. The data structure of claim 14, wherein the namespace table includes a namespace entry for each namespace in the module, the class table includes a class entry for each class in each of the namespaces, and the method table includes a method entry for each method in each of the classes, wherein the namespace entries, the class entries and the method entries store the code coverage information for the respective constructs.

16. The data structure of claim 14, wherein the hierarchy is organized according to the hierarchy of the constructs, proceeding in a parent to child order from the module table, to the namespace table, to the class table and to the method table.

17. The data structure of claim 16, wherein each entry in the plurality of tables includes an identification of the construct for which the entry stores code coverage information and an identification of the construct in the preceding level of the hierarchy to which the construct belongs.

18. The data structure of claim 16, wherein the data structure is stored in at least one ADO.NET DataSet object.

19. A method of formatting code coverage data generated by performing one or more code coverage tests on a program module derived from computer code structured according to a programming paradigm, the method comprising acts of:
organizing the code coverage data in a plurality of tables arranged in a hierarchy having a plurality of levels, each of the plurality of levels corresponding to a respective construct in the programming paradigm used to structure the code; and
storing, in each of the plurality of tables, code coverage information at the level in the hierarchy at which the table is located.

20. The method of claim 19, wherein the hierarchy is stored in at least one ADO.NET DataSet object.
